(19) United States
(12) Patent Application Publication
(10) Pub. No.: US 2013/0282542 A1
(43) Pub. Date: Oct. 24, 2013

(54) METHOD, APPARATUS AND SYSTEM FOR RETRIEVING FINANCIAL DATA

(71) Applicant: Kathryn J. White, London (GB)

(72) Inventor: Kathryn J. White, London (GB)

(73) Assignee: THE ROYAL BANK OF SCOTLAND PLC, Edinburgh (GB)

(21) Appl. No.: 13/449,840

(22) Filed: Apr. 18, 2012

(51) Int. Cl. G06Q 40/00

(52) U.S. Cl. 705/35

(57) ABSTRACT

A method for retrieving financial data for a budget is described. The method includes receiving, by a computer, a request for at least one monetary value representative of a sum of money to allocate for a particular outcome. The request is parsed, by a computer, to determine at least one expense item required to achieve the particular outcome. Ancillary information is retrieved relating to said at least one expense item, the ancillary information comprising a cost value representative of said at least one expense item. The retrieved ancillary information is processed to output said at least one monetary value.

### TECHNICAL FIELD

The present disclosure relates to a method and system for retrieving and processing financial data. In particular, but not exclusively, the present disclosure relates to a method, apparatus and system for providing information relating to a financial goal. The method and system may form part of a networked software application.

### BACKGROUND

A number of software applications are available to help a user manage financial data. The user may be an individual looking to manage their personal finances or a member of a commercial entity looking to manage the finances of the entity. For example, in the latter case, the user may be a director or financial officer of a company or corporation. The software application may allow for the importing of financial, time-series data and the display of subsequently calculated financial metrics. The software application may comprise a standalone software product or may be implemented as a networked service, for example a service accessed over the Internet using a suitable browser.

While these software applications go some way to helping a user manage financial data, and thus help a user manage their personal finances or the finances of a commercial entity, they still require input from the user. This requires the user to have a certain amount of financial knowledge. What is needed is a way to manage financial data that requires less input and financial knowledge from the user.

### SUMMARY

In accordance with a first example, there is provided a method for retrieving financial data for a budget, comprising: receiving, by a computer, a request for at least one monetary value representative of a sum of money to allocate for a particular outcome; parsing, by a computer, the request to determine at least one expense item required to achieve the particular outcome; retrieving, by a computer, ancillary information relating to said at least one expense item, the ancillary information comprising a cost value representative of said at least one expense item; and processing, by a computer, the retrieved ancillary information to output said at least one monetary value.

In accordance with a second example, there is provided an apparatus for retrieving financial data for a budget, comprising a request processor arranged to receive a request for at least one monetary value representative of a sum of money to allocate for a particular outcome, parse the request to determine at least one expense item required to achieve the particular outcome, prepare one or more queries for said at least one expense item, receive, in response to said one or more queries, ancillary information, the ancillary information comprising a cost value representative of said at least one expense item and process the retrieved ancillary information to output said at least one monetary value.

In accordance with a third example, there is provided a system for retrieving financial data for a budget, comprising:

a computing device arranged to generate a request for at least one monetary value representative of a sum of money to allocate for a particular outcome;

an information server arranged to receive the request and generate one or more queries for one or more respective expense items required to achieve the particular outcome; and

one or more reference servers arranged to receive said one or more queries and return data comprising cost values representative of said one or more expense items.

There may be provided a computer program product comprising a non-transitory computer-readable storage medium having computer readable instructions stored thereon, the computer readable instructions being executable by a computerised device to cause the computerised device to perform as described above.

Further features and advantages of the disclosure will become apparent from the following description of preferred embodiments of the disclosure, given by way of example only, which is made with reference to the accompanying drawings.

### BRIEF DESCRIPTION OF THE DRAWINGS

FIG. 1 is a simplified schematic diagram of an exemplary system for obtaining and processing financial data;

FIG. 2A is a simplified schematic illustration showing an exemplary computing device with a first set of interface components for viewing financial information relating to a spending budget;

FIG. 2B is a simplified schematic illustration showing an exemplary computing device with a second set of interface components for viewing financial information relating to a savings target;

FIG. 3 is a flow chart showing an exemplary process for setting a budget for a new saving goal;

FIG. 4 is a simplified schematic illustration showing an exemplary computing device with a third set of interface components for providing budget details;

FIG. 5 is a simplified schematic diagram showing the system of FIG. 1, together with exemplary apparatus for retrieving financial data;

FIG. 6 is a flow chart showing an exemplary method for retrieving financial information relating to a budget;

FIG. 7A is flow chart showing an exemplary process for viewing a budget associated with a saving goal;

FIG. 7B is a flow chart showing an exemplary process for the completion of a saving goal;

FIG. 8 is a simplified schematic illustration showing an exemplary computing device with a fourth set of interface components for viewing and adjusting a budget;

FIG. 9 is a simplified schematic illustration showing an exemplary computing device with a fifth set of interface components for adjusting a budget;

FIG. 10 is a simplified schematic illustration showing an exemplary computing device with a sixth set of interface components for adjusting a spend amount;

FIG. 11 is a simplified schematic illustration showing an exemplary computing device with a seventh set of interface components for viewing budget values;

FIG. 12 is a simplified schematic illustration showing an exemplary computing device displaying an alert message;

FIG. 13A is a first schematic illustration showing an exemplary computing device with an input mechanism for entering a search string;

FIG. 13B is a second schematic illustration showing the exemplary computing device of FIG. 13A following entry of the search string; and

FIG. 14 is a flow chart showing an exemplary process for integrating location data.

### DETAILED DESCRIPTION

Certain software applications allow the setting of a financial task or a purchase category. For example, a software application may import monthly statements from a bank account. The user and/or the software application may categorise individual transactions in the monthly statements. If the transaction data is stored in a database this categorisation may include storing a value in a category field and/or assigning a markup language label or “tag” to the transaction data. The software application may categorise individual transactions using a lookup list or table that maps string expressions located in transaction data, or particular billing entities, to a category. In this case, the software application is then able to display a cumulative total of all transaction amounts for a particular category for a particular time period. For example, the category “utilities” may be applied to transactions containing the words “electricity”, “gas” or “water”, and then the total spend on “utilities” for a month may be displayed.

Certain software applications allow a user to set a budget total for a particular task or purchase category. For example, a user may set a budget total of $150 dollars for the payment of bills categorised as “utilities”. The software application may have functionality to allow a user to graphically or otherwise compare an actual cumulative total for a category with the budget total for the same category. A graphical warning may be displayed when a user exceeds a budget total.

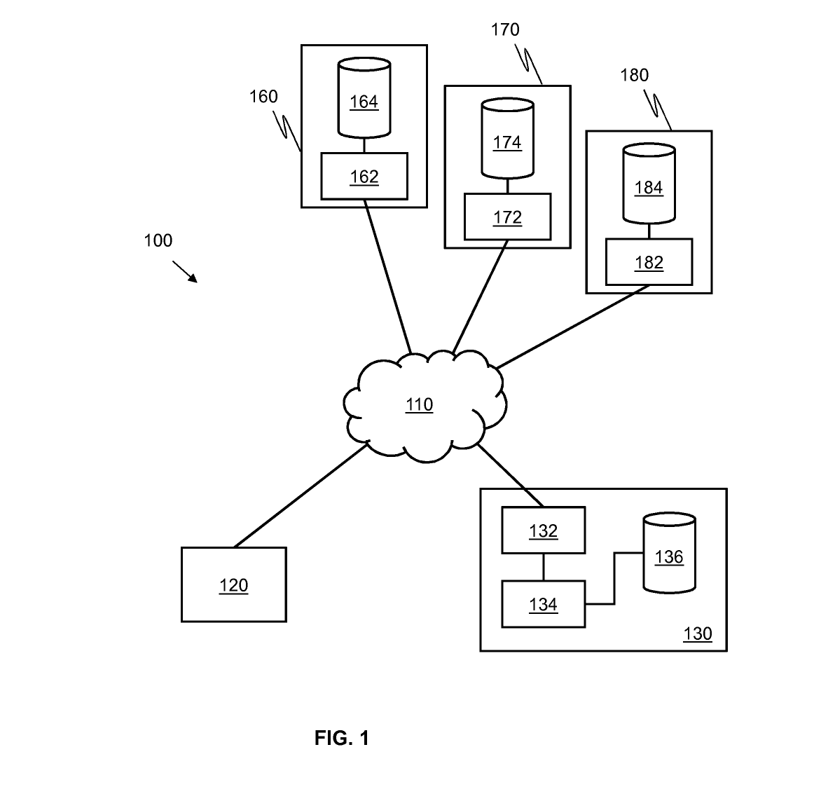

FIG. 1 shows a system for obtaining and processing financial data 100. The system for obtaining and processing financial data 100 comprises a computing device 120 coupled to a network 110. The computing device 120 may comprise a static or portable computing device from, amongst others, the family of mobile devices including mobile or cell phones (including so-called “smart phones”), personal digital assistants, pagers, tablet and laptop computers, content-consumption or generation devices (for music and/or video for example), thin or fat client terminals, personal computers, game consoles and other entertainment devices. The network 110 may comprise one or more local or wide area networks, implementing one or more of wired and wireless technologies. For example, the network 110 may comprise a local area network (LAN) within an organisation and/or a collection of mixed type networks such as the Internet.

An information server 130 is also coupled to network 110. The information server 130 is arranged to supply information to be rendered on a display of computing device 120. For example, the information server 130 may comprise a Hypertext Transfer Protocol (HTTP) server arranged to supply Hypertext Markup Language (HTML) web pages to a client web browser implemented on the computing device 120. Alternatively, the information server 130 may comprise an application server that interacts with a software application stored in the memory of, and operating upon a processor of, the computing device 120. The information server 130 comprises a request processor 132 that is arranged to receive requests from the computing device 120. In certain implementations, the request processor 132 may also perform authentication and/or authorisation of a user of the computing device 120; in other implementations this may be performed by an external server (not shown). The information server 130 also comprises a database interface 134. The database interface 134 is arranged to retrieve information from an information database 136. This information may comprise information that is rendered into an HTML document that is sent to the computing device 120 for display. As well as, or instead of, this function, the information database 136 may comprise information that is used by the request processor 132 to build a dynamic HTML document incorporating data from additional data providers. For ease of explanation, information database 136 is shown as a single database in FIG. 1; however, it may be implemented in practice by two or more databases. If two or more databases are used each database may comprise a portion of a larger distributed database or may comprise a store of functionally discrete data.

In FIG. 1 there are three exemplary data providers: a first data provider 160, a second data provider 170 and a third data provider 180. The first data provider 160 comprises a first network interface 162 that is coupled to the network 110. The first network interface 162 is arranged to retrieve data from a first data source 164. The first network interface 162 may be arranged to process data retrieved from the first data source 164 before sending said data to one or more of the information server 130 and the computing device 120. The second data provider 170 and the third data provider 180 likewise respectively comprise a second network interface 172 and a second data source 174, and a third network interface 182 and a third data source 184. Even though three data providers are shown in FIG. 1, in practice any number of data providers may be used.

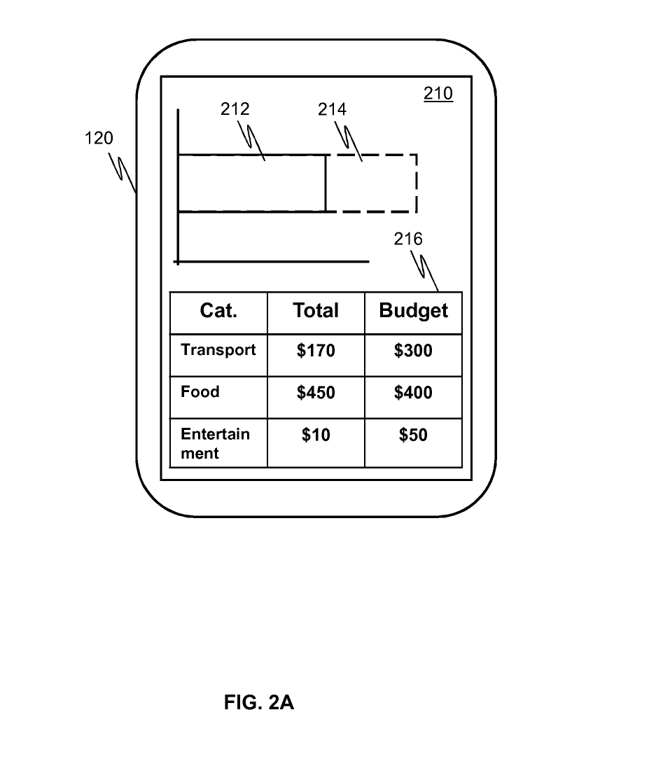

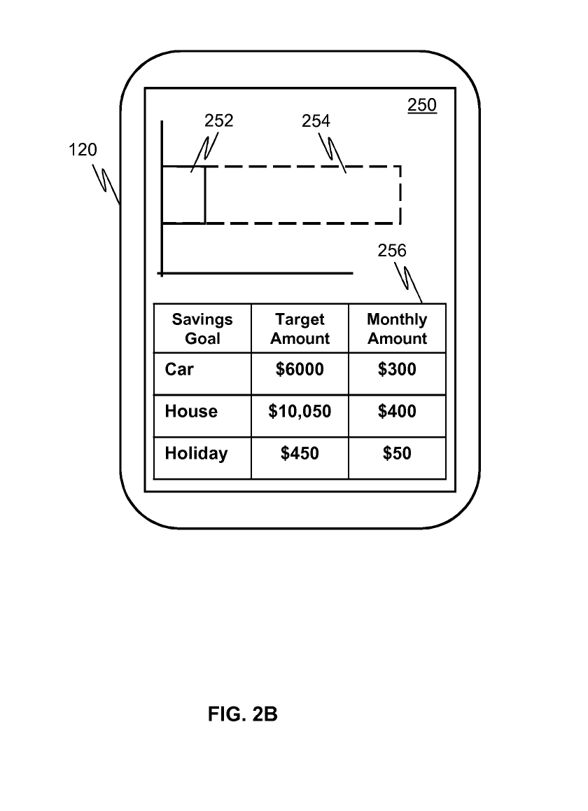

Each data provider may be arranged to provide a different set of financial data. For example, the first data provider 160 may belong to a credit-card account supplier, the second data provider 170 may belong to a current account supplier and the third data provider 180 may belong to a savings account supplier. The user of the computing device 120 may have an account with one or more of these suppliers. Hence, each of the data sources may store account information for the user. Alternatively, the data providers may represent geographically distinct suppliers, for example, one for a bank in a first region and a second for the same bank in a second region. This information may be aggregated by one or more of the information server 130 and an application on the computing device 120 in order to produce an interface such as that shown in FIG. 2A.

As an example, a user may access a website or networked application on the computing device 120. In this case, the computing device 120 communicates with the information server 130 to display a log-in screen. The user enters in one or more authorisation details, such as a username and password or passcode, which are validated by either the request processor 132 or an external authorisation server. Following a successful authorisation, details for the user are retrieved from the information database 136 under command of database interface 134. These details comprise further authorisation data for each of the first data provider 160, the second data provider 170 and the third data provider 180. The details may comprise a Uniform Resource Identifier (URI) for a service supplied by each data provider that allows access to account data stored on each of the data sources. The details may also comprise a log-in macro that specifies a series of commands to authenticate the user with the aforementioned services. For example, the details may include a series of HTML commands that act to authenticate the user. The details are processed and sent to an appropriate data provider by the request processor 132. In one embodiment, each data provider returns account information that is processed by the request processor 132 before being stored in the information database 136 by the database interface 134. This stored account information is then used to assemble an HTML document that is sent to the computing device 120 over the network 110. In certain embodiments, the request processor 132 may supply a document to the computing device 120 with links to information provided by each of the data providers, i.e. such that the document displayed on the computing device 120 uses information received directly from the data providers. An application on the computing device 120 may then dynamically assemble the supplied account information to provide an interface on a display of the computing device 120. In certain embodiments, information may be temporarily stored, i.e. cached, at the information server 130. In certain embodiments, the information server 130 may send data to an application running on the computing device 120, said application then rendering the data for display on the computing device 120. The exact implementation will depend on security requirements and the nature of the networked devices and services.

FIG. 2A shows an exemplary interface that may be generated by the above process. FIG. 2A shows an exemplary computing device 120, in this example a mobile computing device with a display and wireless connectivity, with a first user interface 210 displayed on the display. The first user interface 210 may be generated by an application, such as a web browser or dedicated application. This application is implemented using computer program code stored in memory that, in use, is processed by a processor of the computing device 120. In the example of FIG. 2A, transaction data from one or more accounts in the name of the user is received by the information server 130 from one or more of the first data provider 160, the second data provider 170 and the third data provider 180. For example, the transaction data may comprise a portion of account data for the user stored in one or more of the first data source 164, the second data source 174 and the third data source 184. An exemplary item of transaction data may include, amongst other items: a transaction date, a transaction type, a transaction description and a transaction amount; e.g. 5 Mar. 2013-Direct Debit-BEST BUS-$35.00. The latter may be positive for deposits and negative for debits. This transaction data is categorised, either automatically or following labelling by the user, and stored in the information database 136. In FIG. 2A three exemplary categories are shown in a first level budget table 216: “Transport”, “Food” and “Entertainment”. So the exemplary transaction item above may be categorised as “Transport” as it contains the string “BUS” in its description. Either locally on the computing device 120 or remotely at the information server 130, the cumulative total of transaction data for a particular category is calculated for display in the first level budget table 216. This cumulative total may relate to a particular time period, such as N days or months, or may relate to all recorded transaction data. Any time period may be calculated based on a transaction data within a transaction item. The particular time period may be selected by the user. The cumulative total may represent a monetary amount, for example a total in a particular currency such as US dollars. The monetary amount may represent spending by the user in transactions relating to the category. FIG. 2A shows a spend of “$170” on transactions relating to “Transport”, a spend of “$950” on transactions relating to “Food” and a spend of $10 on transactions relating to “Entertainment”.

For one or more of the categories displayed in the first level budget table 216 a graphical indicator may be provided. FIG. 2A shows an actual spend graphic 212 in the form of a bar in a bar chart. The actual spend graphic 212 may relate to one of the categories. Graphical indicators may be provided for any number of categories.

FIGS. 1 and 2A show how a user may obtain and view financial data. To aid financial planning a user may also require some facility to budget for future spending. In order to budget, i.e. to suitably allocate finite financial resources, one or more outcomes are defined. They make take the form of savings goals, e.g. allocation of financial resources to save for a particular outcome (i.e. an amount to aim not to spend), and spending budgets, e.g. target spending in a particular category (i.e. an amount an entity plans to spend). For example, if a user is looking to buy a new motor vehicle, either personally or on behalf of a commercial entity, a savings goal in the category of “Car” may represent allocating financial resources for the purchase of the motor vehicle and a spending budget in the same category may represent the running costs related to operating the motor vehicle following a purchase made with the allocated financial resources. Another desired outcome in the form of a savings goal may be a financial amount associated with a particular pension income, e.g. an income of M thousand dollars.

Returning to the example of FIG. 2A, the first user interface 210 shows a further column in the first level budget table 216 for a budget value. In FIG. 2A this budget value represents a target spend for time period for a particular category. The exact form of the budget value may depend on any user accounts being monitored. For example, a transfer of X dollars from a current account to a savings account may be shown as a deduction from the current account (i.e. a negative value) and a deposit into the saving account (i.e. a positive value). In FIG. 2A, category “Transport” has a target spend of “$300”, category “Food” has a target spend of “$400” and category “Entertainment” has a target spend of “$50”. For example, a budget value of “$50” for “Entertainment” may mean that a user only plans to spend “$50” in a month on entertainment-related purchases. In the example shown in FIG. 2A, they have actually spent $10, this spend value being retrieved from a user's current account data stored on one of the data providers 160, 170, 180.

FIG. 2B shows a second user interface 250 for displaying data associated with a savings goal. In FIG. 2B three exemplary savings goals are shown in a first level savings table 256: “Car”, relating to saving for a car; “House” relating to saving to purchase a house, e.g. for a deposit; and “Holiday” relating to saving for an annual holiday. The first level savings table 256 also shows a column detailing a total target amount to save (“Target Amount”). A target total amount to be saved may be represented graphically by graphical indicator 254. A further graphical indicator 252 may either indicate an amount saved per time period (e.g. per month) or a total amount saved to compare to a target total amount to be saved. Additional columns may be added to the first level savings table 256 in some implementations. For example, a total amount saved so far may be added. This may, for example, be retrieved as data representing a savings account balance from one or more of the first data provider 160, the second data provider 170 and the third data provider 180.

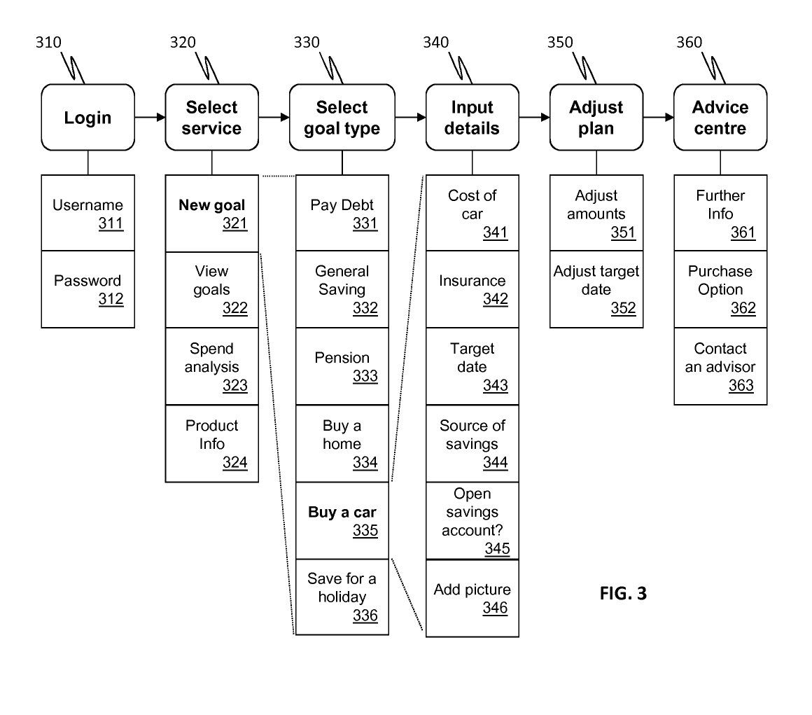

FIG. 3 is a flow chart showing an exemplary process for setting a savings goal that may make use of the system of FIG. 1. At step 310, a user logs in to the system. As an example, a user may access a website or networked application on the computing device 120. In this case, the computing device 120 communicates with the information server 130 to display a log-in screen. The user then enters in one or more authorisation details, such as a username 311 and password or passcode 312, which are validated by either the request processor 132 or an external authorisation server. Following a successful authorisation, the user is presented with a number of services at step 320. For example, these services may be provided by exchanging information between computing device 120 and information server 130, with particular functionality being implemented on one or more of the computing device 120 and information server 130 as appropriate for the particular implementation. In the example of FIG. 3, four services are available: setup a new savings goal 321; view any saving goals that have been previously setup 322; perform an analysis of spending relating to one or more accounts 323; and view product (‘info’) information 324. The product information 324 may comprise information regarding related financial products and/or contact information as well as the ability to message an adviser. As an example, FIG. 2A may show the result of a service to perform an analysis of spending relating to one or more accounts 323 and FIG. 2B may show the result of a service to view any saving goals that have been previously setup 322.

The subsequent steps involved in setting up a new savings goal 321 are shown in FIG. 3. At step 330, a user is given a number of exemplary savings goals. In FIG. 3 there are six savings goal templates: saving to pay debt 331; general saving 332; saving for a pension 333; saving to buy a house 334; saving to buy a car 335; and saving for a holiday 336. In one implementation, one or more of the savings goals may be presented to a user on the computing device 120 and the user may select or browse through available goals using gestures on a touch-screen interface. A user may also be given the opportunity to define their own particular savings goal (not shown in FIG. 3). Goals may be added or removed to the selections available at step 330. An available goal may be viewed as a complete user interface filling the whole of the screen of the computing device 120, wherein navigation is performed by swiping left or right to view another user interface. In this manner, further goals may be easily added by adding to the number of viewable user interfaces.

The example of FIG. 3 shows the user selecting a “buy a car” savings goal 335. They may do this by tapping on this particular option on the screen of the computing device 120. Following this selection the user is given the option to input one or more details relating to the goal at step 340. In FIG. 3, a user is given the option to provide: a cost for a new car 341, an insurance amount 342, a target date to reach the savings goal 343, a source of savings 344, and a picture of their proposed vehicle 346. They may also be given the option to open a savings account 345 if they have no source of savings to select at step 344. In accordance with later described examples, the user is given the option to automatically complete details such as the cost of the car 341 and the insurance amount 342, which simplifies the process for the user and results in a more accurate savings goal. After the system receives the details from step 340, a savings plan is generated. This is a schedule of saving to meet the savings goal. For example, the cost of the car 341 plus insurance 342 may equal a savings total to be achieved by the target date 343. For example, the savings total may be divided by a number of time periods between the present date and the target date 343 (e.g. split into monthly amounts to save). At a time after a savings goal has been set up the user is given the option to adjust the savings plan. For example, a user may adjust amounts to be saved for each time period 351 and/or the target date 352. While working towards a goal a user may be offered suitable advice based on their defined goal. For example, information on a particular goal or the saving process may be supplied to the user at step 361. For example, if a user is setting a pensions savings goal 333 they may be offered background information on pensions and simulations of predicted results in retirement based on a current savings rate. Users may also be provided with tips on how to save effectively, retrieved based on the size of the savings in the saving plan, and advice on how to cut down certain areas of their spending, such as utility bills and grocery shopping, which may be tailored for the users particular information stored at the information server 130 or in other locations. For particular savings goals a user may also be able to view related purchase options 362, for example, if the user is saving for a holiday they may be supplied with details from a holiday booking website. They may also have the option to contact an advisor 363, which may supply advice through electronic messaging or via a voicecall as examples.

Following the method of FIG. 3, the saving goal “Car” shown in FIG. 2B may have been set up using option 335. Likewise, the goals “House” and “Holiday” may be set up using options 334 and 336. In some implementations a process different from that shown in FIG. 3 may be used to set the savings goals of FIG. 2B.

When using a budgeting application such as one relating to spending targets and/or savings goals similar to those shown in FIGS. 2A and 2B, there is the problem of setting an accurate budget level or target goal amount. Certain applications enable a user to manually enter a budget value or target goal amount. For example, a user may manually enter each of the budget values in the “Budget” column of exemplary first level budget table 216 or each of the target goal amounts in the “Monthly Amount” column of first level savings table 256. However, a user needs to be able to enter a realistic budget value or target goal amount; if a budget value is too low, a user may overspend when trying to work to the budget value, if a target goal amount is too high, a user may unnecessarily divert funds from other areas. For example, most lay users will not know what size of monthly contribution is required for a particular pension income. Even financial experts may find setting such a budget value or target goal amount difficult, as it may depend on current market factors. Certain embodiments provide a solution to this problem.

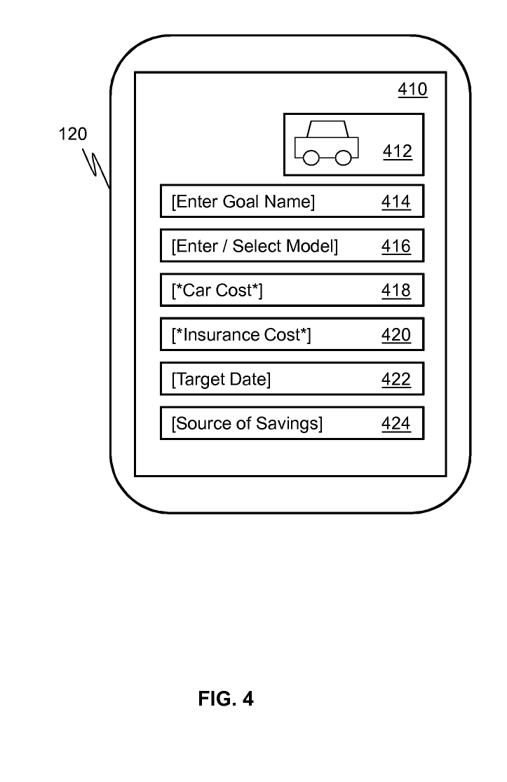

FIG. 4 shows a simplified schematic diagram of exemplary computing device 120 with a third user interface 410 to be used for setting a budget level or target goal amount. The third user interface 410 is shown for example only and may vary in at least shape, size and location depending on the implementation. The third user interface 410 may be used to enter one or more details 341 to 346 as part of the input details step 340 of FIG. 3. For example, a picture control 412 may be selected or edited to enable a user to upload a picture associated with a new or selected goal, in this case a picture of a car. This action fulfils option 346 in FIG. 3. An uploaded picture may also be subject to image recognition algorithms to determine information related to a savings goal; for example, a make and model of car may be automatically identified from a snapshot of a motor vehicle. A goal name control 414 enables a user to enter a name for the goal, for example, via an on-screen keyboard. A unique goal name allows the goal to be quickly selected at a later point in time. A model selection control 416 enables a user to enter or select a particular model of vehicle, which may be performed in multiple steps (e.g. by navigating a hierarchy of options such as manufacturer, car type, number of doors etc.). In certain applications a user may manually enter the model of car then manually enter a car cost 418 and an insurance cost 420, for example to fulfil steps 341 and 342 of FIG. 3. The user may then set a target date 422 to fulfil step 343 of FIG. 3 and a source of savings 424 to fulfil step 344 of FIG. 3. The source of savings may be deposits into a savings account or transaction items relating to received income or sale of goods.

In accordance with examples described herein, methods and systems are provided to retrieve data in order to set an accurate budget level. For example, as indicated by the starred (“*”) controls in FIG. 4, certain budget or goal details may be automatically populated to ensure accuracy and realism. In FIG. 4, according to particular examples, data relating to car cost 418 and insurance cost 420, so-called ancillary data for a budget level or goal amount, are retrieved automatically based on information associated with the user, for example an entered or selected model in control 416.

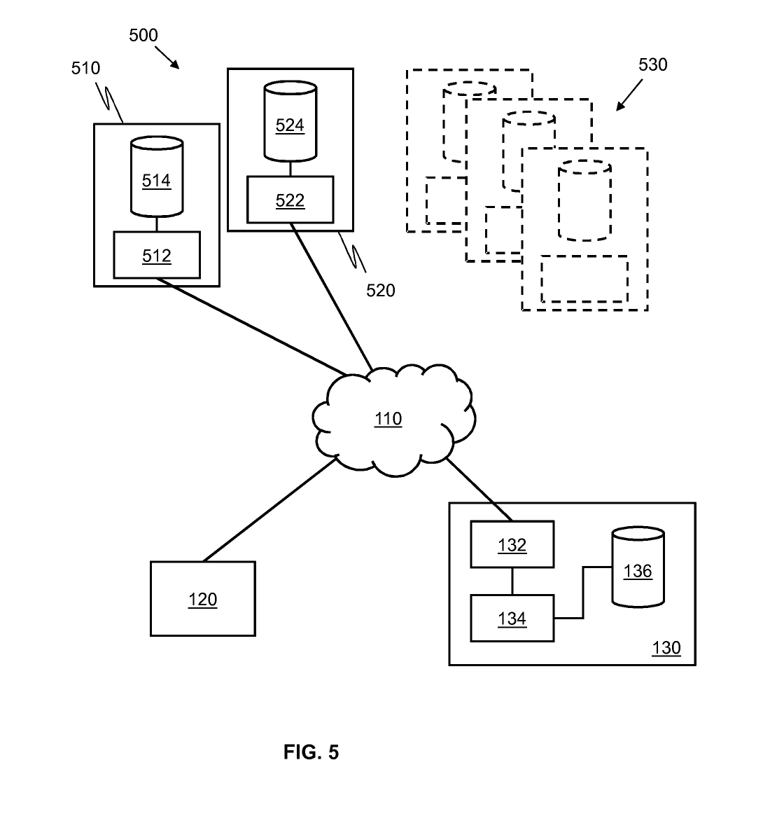

FIG. 5 shows an exemplary system for retrieving data in order to set an accurate budget level or target savings goal. FIG. 5 shows the system for obtaining and processing financial data 100 from FIG. 1 with additional budget references 500. The data providers 530 comprise the data providers from FIG. 1 but are shown in the background of the Figure, i.e. with dotted lines, for clarity. The budget references 500 are sources of reference information for a budget value or target savings goal and comprise a first reference server 510 and a second reference server 520. The first reference server 510 comprises a first reference interface 512 and first reference data 514. The second reference server 520 comprises a second reference interface 522 and second reference data 524. Both the first reference interface 512 and the second reference interface 522 are coupled to the network 110.

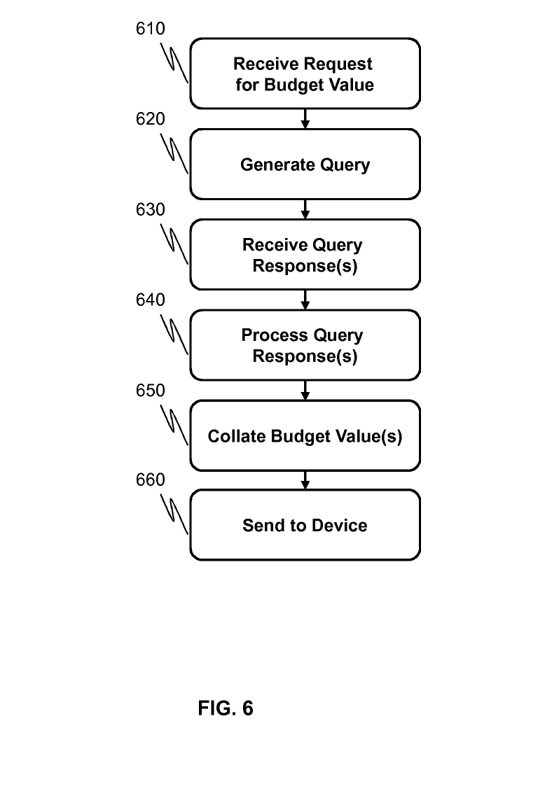

FIG. 6 shows an exemplary method for retrieving ancillary information for producing an accurate budget value or target savings goal. At step 610 a request for a budget value or target savings goal is received. In the present example, this request may be compiled by the computing device 120, either in response to a user selecting a control element on an interface of an application or in response to a process forming part of the application. For example, a request may be generated after a user enters or selects a car model using control 416 in FIG. 4. In this example, the request comprises a category of financial transactions or a financial aim or goal, i.e. an aim or goal of achieving a particular outcome. In certain cases, the computing device 120 stores information representing the current state of an application running on the computing device 120. In the example of FIG. 4, the computing device 120 stores that “new goal” 321 and “buy a car” 335 have been selected. If the user selects a car model using control 416 the request could comprise information indicating that the request relates to a new goal with a category or financial goal of “Car”, respectively representing selections 321 and 335, together with information on the model of car that has been selected using control 416. The category or financial goal may comprise a category or financial goal that is stored in the information database 136. These categories or financial goals may be synchronised between the information database 136 and local storage of the computing device 120, for example the goal types displayed at step 330 in FIG. 3 may represent available categories or goals stored in the information database 136. In this case a unique identifier such as a URI or alphanumeric code may be sent from the computing device 120 to the information server 130 to identify the category or financial goal for which a budget value or target savings goal is required. In certain embodiments, the category or financial goal may be implicit in a search string or other data entered by a user, for example the category “Car” may be implied by the receipt of a model of car as part of the request. The request may also comprise a time field to identify the period over which the budget value or target savings goal is to apply; for example, in the former case it may relate to a yearly, monthly or weekly spend. This latter information may have been selected by the user as part of setting a target date at step 343. The request may be linked to the user of the computing device 120, either using a field in the request or session information.

In the present example, the request is received at the request processor 132. The request processor 132 processes the request so as to generate a query relating to the request at step 620. The query comprises a request for information relating to one or more expense items that are associated with the category or financial goal, i.e. comprise items that the user is likely to have appear as transaction items if an outcome embodied by the category or financial goal is achieved. In one case, a request for a budget value may be converted into a request for one expense item, for example a request in the category “Holiday” may result in information relating to a single expense item “holiday cost”, representing, say, the cost of a package holiday. In other cases a request for a budget value may be converted into a request for two or more expense items, such as the example of FIG. 4, wherein the expense items may comprise one or more of the cost of the car and the cost of an insurance policy for the car (e.g. an annual premium).

There are two possible query types that may be used: a local query and a remote query. A local query is sent to the database interface 134. The database interface 134 then uses the information received from the request processor 132 to query one or more data sources local to the information server 130. This data source may be the information database 136 or may be one or more other local databases. In a first case, the data source may store a number of cost values relating to a variety of expense items. In one example, an average holiday cost value may be stored. In this case, a record in a local database may comprise at least: an identifier for “Holiday”, an identifier for expense item “holiday cost” and a value for the expense item. Hence, at least a portion of a local query for the category “Holiday” may comprise a query for a budget value for “holiday cost”. The query may be at the level of expense item or category or financial goal identifier.

A remote query is similar to a local query but it uses a remote data source coupled to the network 110. In this case the request processor 132 may consult a lookup table on receipt of a budget value or target saving goal request to determine one or more expense items and thus the most appropriate data source or service to supply at least a portion of the budget value or target saving goal. For example, a savings goal of “buy a home” 334 may have expense items of: “legal fees”, “property taxes”, “agent fees”, and “house cost”. Each associated expense items may have associated URLs that specify one or more of the first reference interface 512 and the second reference interface 522. The request processor 132 processes the received request into a suitable form to be forwarded to one or more of the two interfaces. The appropriate one of the two interfaces then receives this second request and uses the information carried therein to retrieve an appropriate cost values for the expense items from the first reference data 514 and/or the second reference data 524.

In certain embodiments the local or remote query may comprise a plurality of queries. For example, two or more of, amongst others not shown, the information database 136, the first reference data 514 and the second reference data 524 may be queried. This may be the case where the budget value or target saving goal comprises a compound value or goal consisting of budget values or cost values for a plurality of expense items. In this case, the information server 130 stores a mapping between a category or a financial goal and two or more expense items that form part of said category or financial aim or goal (e.g. a mapping between a savings goal of “buy a home” 334 and expense items of: “legal fees”, “property taxes”, “agent fees”, and “house cost”). Hence, four queries may be compiled to retrieve cost values for these four expense items, which may then be combined into a single cost value for the category “House”.

As shown with the example of FIG. 4, a set of one or more queries may also use information provided by, and/or retrieved in association with, a user. In this example, two queries may be generated based on a mapping between the goal “Car” and the expense items “cost of car” and “insurance”. Each query may comprise a model identifier, e.g. “CHEV-VOLT-1.4L”, or string description, e.g. “first generation Ford Mustang”. Hence, for the expense item “cost of car” a query may be sent to first reference server 510 together with a model identifier so as to retrieve a car retail cost value associated with the model identifier from the first reference data 514. Likewise, for the expense item “insurance” a query may be sent to second reference server 520 together with a model identifier so as to retrieve an annual insurance cost value associated with the model identifier from the second reference data 524.

Responses from one or more queries are returned to the request processor 132 at step 630. The request processor 132 processes information returned by the one or more queries at step 640. This processing may comprise extracting information in a returned message and formatting any numerical value. This may be required if two or more queries are of different types, for example if they access different network services. For example, values for expense items “cost of car” and “insurance” may be formatted for respective display within controls 418 and 420. At step 650 one or more budget values or saving goal target values are collated to be sent to the computing device 120. This may involve combining or summing numerical values from one or more remote and/or local queries or combining cost values into one or more response messages. It may also comprise adjusting one or more budget or saving goal target values to conform to a required time period, for example converting yearly values into monthly values by dividing by twelve. These temporal calculations may alternatively be performed by the computing device 120. The collating step may also comprise including other field values that were returned with the one or more queries in a response to be sent to the computing device 120, such as a text description, a hyperlink to the information source, any caveat information etc. At step 660, a response message, prepared as an output to step 650, is sent to the computing device 120 over the network 110. The computing device 120 is arranged to receive the response message and process the ancillary information therein. This ancillary information relating to a category or financial goal is then displayed to a user. For example, this may be in the form of displayed values in controls 418 and 420, which may be editable by a user, or in the form of a summed budget value such as those displayed in the “Budget” column of the first level budget table 216 in FIG. 2A or a target saving amount displayed in one or more of the “Target Amount” and “Monthly Amount” columns of the first level savings table 256 in FIG. 2B.

Following the method of FIG. 6, one or more budget or saving goal target values for a budget category or goal are returned. In the example of FIG. 4, two budget values for two expense items are returned to complete the entered details for a newly defined savings goal. Once the budget or saving goal target values are returned, and are visible to a user via controls 418 and 420, the user may confirm the creation of the new saving goal. This may determine an amount of money to save each month, e.g. to transfer to a selected saving account, such as the “Car” budget of $300 in table 256 of FIG. 2B.

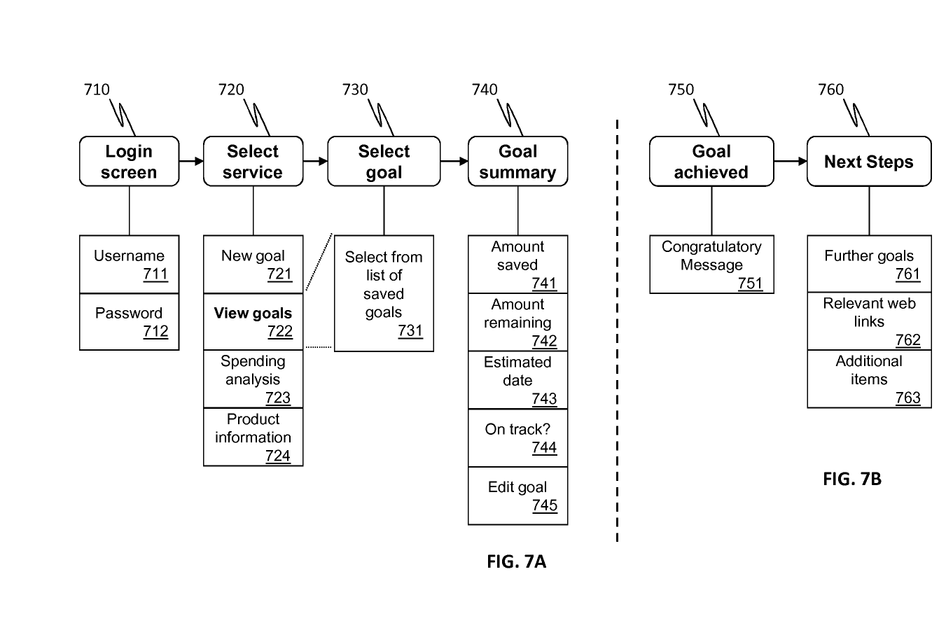

FIG. 7A is a flow chart showing an exemplary process for viewing a budget associated with a savings goal. For example, this savings goal may be the goal determined using the described process of FIG. 3. As with the process of FIG. 3, at step 710 a user logs in to their account using a username 711 and password 712 and is presented with a number of services at step 720 via the interface of computing device 120. In the case of FIG. 7A, the “view goals” option 722 is selected by a user, which at step 730 allows the user to view one or more previously defined goals. Using option 731 a user may select a particular goal for display, for example based on a previously defined unique goal name. At step 740, for the selected goal, one or more of the following are displayed to the user: the amount saved so far 741; the amount left to save 742; the estimated date 743 a saving goal will be reached based on current levels of savings, for example if the user is saving more than budgeted every month; an indicator displaying whether the user is on track 744 to reach the savings goal, for example based on the amount saved so far and/or an average amount saved per time period; and an option to edit 745 a previously defined goal. These may be displayed using graphical and/or text indicators. When a user selects the option to edit 745 a previously defined goal they may be presented with a step similar to 350 in FIG. 3, allowing them to adjust elements of the goal or savings plan.

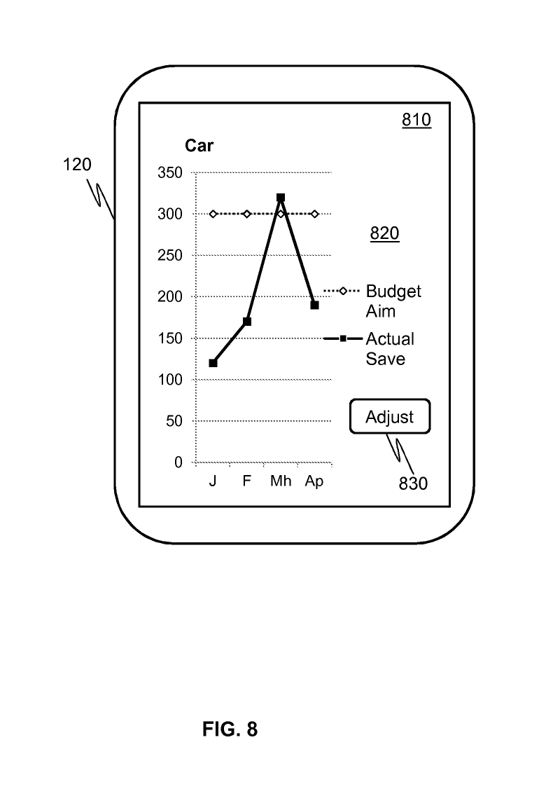

In an example, after selecting a goal in step 730, a graphical indication of progress for a particular aim or goal is displayed to the user. This is illustrated in FIG. 8. FIG. 8 is a simplified schematic illustration showing an exemplary computing device with a fourth user interface 810 for viewing and adjusting a budget target, in this case a savings goal for a car. As shown in FIG. 8, using the budget values derived from returned ancillary information, a monthly savings target of $300 is determined. In the fourth user interface 810, the target monthly amount is charted as a data point for each month and is compared to the actual amount a user saved for that month. For example, the latter information may be derived from data representing transactions performed in relation to a particular savings account of the user, e.g. cumulative deposit amounts for a month. The resulting chart 820 shows a user's progress. In the example of FIG. 8 a user is below their target savings amount for 3 out of the displayed 4 months. This implies that the savings plan will need to be adjusted. In this regard an “adjust” control 830 is provided. In another example, a user may use an interface gesture to trigger an adjustment process, for example they may select the data points for the monthly target, or the line defined by the data points, and drag the selected item(s) across the screen of the computing device 120 to adjust the monthly amount. Other display screens may also be used to visually display progress for a particular budget or saving goal relative to time. A user may also be able to review completed goals.

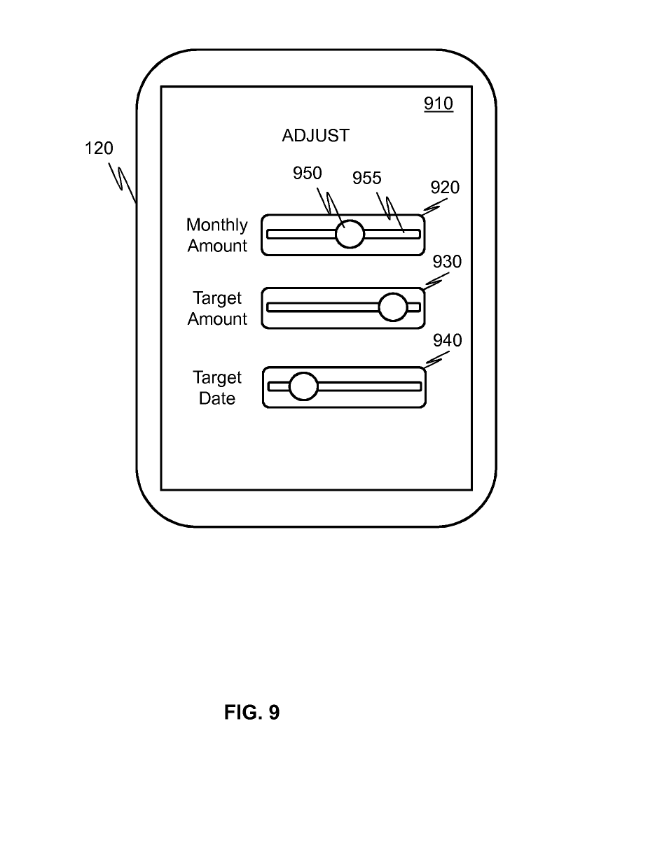

FIG. 9 is a simplified schematic illustration showing an exemplary computing device 120 with a fifth user interface 910 for adjusting a budget. For example, the fifth user interface 910 may be displayed as part of step 350 in FIG. 3 or in response to selecting “adjust” control 830. FIG. 9 shows one particular set of user interface components for adjusting a budget but other components may alternatively be used depending on the implementation. The fifth user interface 910 enables a user to adjust the parameters for one or more of: a monthly amount to be saved 920; a target amount to be saved 930; and a target date 940 to achieve a savings target. Graphical controls in the form of sliders are provided, wherein a range of values is defined by bar 955 and a particular value form this range is selected by sliding control 950 left and right along bar 955.

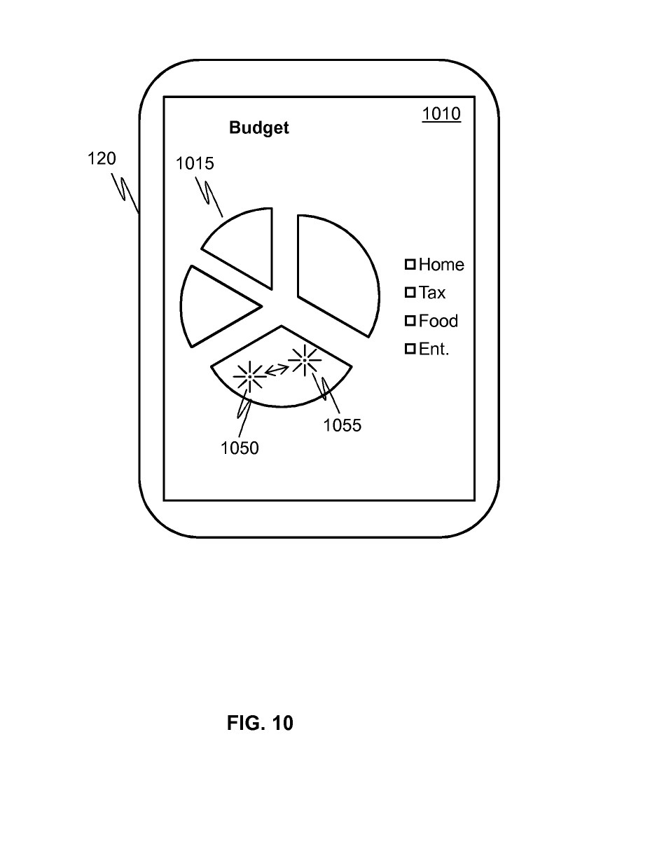

In one example, a user may be provided with a user interface to help them implement a savings plan, e.g. to help them plan exactly how to save a target amount for a time period. This is shown in FIG. 10. FIG. 10 shows a sixth user interface 1010 for the computing device 120. The sixth user interface 1010 may be displayed to a user as part of step 340, for example after determining a target amount to save for a particular time period. In some implementations, it may be shown following the setting and/or adjustment of a target savings amount using the fifth user interface 910. The sixth user interface 1010 provides an indication of a user's or entity's spending for a particular time period. For example, FIG. 10 shows four categories of financial spending: home, tax, food and entertainment (“ent.”). These are displayed in graphical form in the shape of a pie-chart 1015. To meet a particular budget level or target goal amount a user may direct funds from one or more established spending category, e.g. may need to reduce spending in one or more categories to meet a target goal amount or reducing spending in a particular category to meet a particular budget level. In FIG. 10 this is achieved by performing an interface gesture in relation to a sector of the pie chart, such as a “pinch” gesture in relation to two contact points 1050 and 1055 on a screen of the computing device 120. For example, a first contact point 1050 proximate to a first edge of a sector is mapped to the first edge and a second contact point 1055 proximate to a second edge of a sector is mapped to the second edge, with the sector between the two edges being selected. By adjusting one or more of the contact points 1050 and 1055 the user can adjust the size of the sector, which is proportional to a percentage spend for a category. For example, a user may select a sector representing spending on entertainment in a month as described above, and reduce the size of the sector, representing a reduction in spending on transaction items with a category of entertainment, with the difference between the original spend amount and the reduced spend amount being used to contribute to the savings goal. The reduced entertainment spend value may then be used as a spending budget value for the category entertainment. Budget values for one or more categories up to all spending categories may be set and/or adjusted in this manner.

In certain implementations, instead or as well as the manual adjustments described above, a data-backed algorithm is used to produce an optimal spread of cost-cutting across one or more spending categories. A weighted average of other users' manual adjustments may be used to automatically set a spending target for one or more categories. As an example, data detailing manual adjustments, recorded with a user's permission by the application on computing device 120, may be sent to information server. This data may be anonymised and averaged over multiple users so as to determine appropriate adjustment weights for each category. For example, if users regularly adjust a “Cash ATM (Automated Teller Machine) Withdrawal” category by three times the amount they adjust a “Mortgage Payments” category; this ratio may be used to automatically reduce spending in the “Cash ATM Withdrawal” category by three times the amount of a reduction in the “Mortgage Payments” category for a new user.

The sixth user interface 1010 of FIG. 10 may also be used at a later stage when adjusting a spending target or target savings amount. For example, if a user is not meeting a particular budget level or target goal amount, the user may be presented with the sixth user interface 1010 to reduce other items of spending.

Turning to FIG. 7B, another example of the retrieval of ancillary information relating to a budget value or financial goal will now be described. FIG. 7B is a flow chart showing an exemplary process for the completion of a saving goal. In certain examples, after a user has set up a budget or a saving goal, their progress towards the goal is monitored by one or more of the computing device 120 and the information server 130. For example, at regular time intervals such as monthly, and/or when a user chooses to activate an application running on the computing device 120, a savings goal target value may be checked against the amount of money deposited in a particular savings account. In one case, the total monetary amount in a saving account is retrieved by the information server 130, for example from a first data provider 160 that supplies account data following appropriate authentication as described with relation to FIG. 1. In another case, data for all deposit transactions with a particular identifier is retrieved and summed; for example, as part of the savings goal setup process all deposit transactions relating to the “Car” savings goal may be tagged with an alphanumeric string, e.g. “savings_Car123”. In either case, if the cumulative deposit total is greater than or equal to the savings goal target value then at step 750 a goal achieved state is reached. In the example of FIG. 7B, when this goal is reached, a congratulatory message and/or user interface is displayed to the user at step 751.

Following step 750, a “next steps” user interface is displayed to the user of the computing device 120. This interface offers a user options for tasks following the completion of a savings goal. In the example of FIG. 7B, three options are provided. A first option allows a user to set further savings goals 761. For example, the user may be directed to a “new goal” process, similar to that of option 321 in FIG. 3. In certain cases the new savings goal is associated with the completed goal. A second option provides a user with a number of relevant Internet links based on their completed goal. In one case, the information database 136 may store one or more URIs for each category or savings goal type. For example, on completing a savings goal relating to saving for a holiday, the user may be offered URIs for travel advice websites, passport completion or packing checklists. For a motor vehicle purchase, hyperlinks to motoring websites may be provided. A third option is to provide the user with a number of additional items 763 they may wish to purchase or budget for following the completion of the savings goal. Using the same holiday savings goal example, data may be retrieved from the databases of one or more online retail outlets, the data relating to holiday-related goods such as suncream, language phrasebooks, luggage and car hire. For a motor vehicle purchase, tips on how to purchase and/or maintain a motor vehicle may be displayed. If the additional item is a large value item, for example following the purchase of a house a user may wish to save for white goods or home furnishings, then a new savings goal can be set up, again using a similar process to option 321 in FIG. 3 if required.

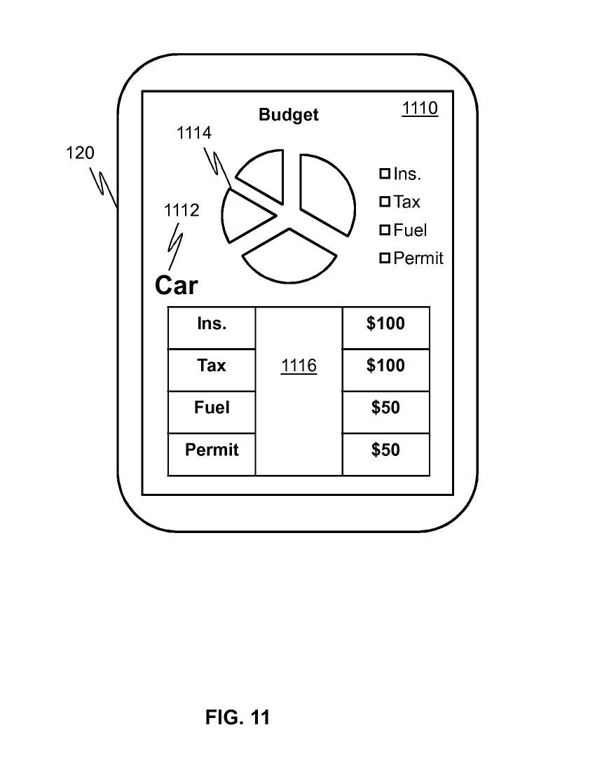

FIG. 11 is a simplified schematic illustration showing an exemplary computing device with a seventh user interface 1110 for viewing budget values. In one example, FIG. 11 shows budget values set following the completion of a savings goal. In this example, a user has completed the task of saving an amount of money relating to a car 1112. They have completed the process of FIG. 7B and selected the additional items 763 option. In this case, a request is made to the information server 130 for budget values for expense items that are required after a user has purchased a motor vehicle. This may follow a process similar to that described in association with FIG. 5, e.g. the information server 130 may look up a number of associated expense items from with local information database 136 or one or more reference servers 510, 520. Monetary expense values associated with each expense item are then retrieved as budget values, for example as described with relation to FIG. 5. These may be the average of a number of transaction items for a number of users, for example the average of all transaction items within a month classified as the category “fuel”. The retrieved budget values are then returned to the computing device 120. In FIG. 11, the expense items associated with the completion of a “Car” savings goal comprise expense items associated with the operation of a motor vehicle. In the present example, these include: insurance (“Ins.”), road taxes (“Tax”), fuel costs (“Fuel”) and parking permit costs (“Permit”).

An exemplary implementation to retrieve and display the second level budget values displayed in FIG. 11 will now be described. First the overall category for the budget values, or the type of recently completed savings goal, is sent as a request to the request processor 132. The request processor 132 parses the request to determine an associated category identifier, in this case one that identifies the running costs associated with a motor vehicle, e.g. “Car_Running”. Information that was stored in relation to any completed saving goal may further be provided, either in the request or retrieved by the request processor by reference to information stored in the information database 136 or a remote data store. For example, the make and/or model of car, or budgeted insurance policy that formed part of the original savings goal may be retrieved for use as constraints in information queries. The request processor 132 then sends a first query to database interface 134 to retrieve one or more URIs relating to the category identifier from the information database 136. The first query may additionally comprise filter information to select a particular subset of URIs from the information database 136. For example, user information such as the home location of a user and/or the age of the user may be used to exclude or include particular URIs for the “Car” category, such as those with local or age appropriate ancillary information. The URIs, which may be URLs or a server application program interface (API) together with zero or more parameters, are returned to the request processor 132 by the database interface 134. The request processor 132 then composes four remote queries using the URIs and optional further information returned by the database interface 134. These remote queries are then sent to four remote servers, for example including budget references 500, which return a response message. The response message may comprise a numerical parameter, an electronic document such as an HTML page, or a “not found” response.

For example, for an insurance second level budget value the URI may comprise a URL specifying a function call or API on a server belonging to an insurance company and an “age” parameter value. The server may then run a function to retrieve an average age appropriate insurance cost for the user that is returned as a marked-up data document (e.g. an eXtended Markup Lanaguage—XML-response). For example, an insurance company or a price comparison service may provide an API to return an insurance quote. It may be that a macro simulating a user interacting with an insurance company server or a price comparison service is required to retrieve the insurance quote value. For tax, any previously-stored make and/or model information may be used to determine a road tax amount, for example using state or federal government databases. For parking permit costs, the first query may include a residency state or region (e.g. California) so that a URL appropriate for that state or region is returned. The URL may comprise an HTML document for a state parking agency that is returned to the request processor 132. The request processor 132 may be arranged to extract a monetary value from the HTML document for the second level budget value using natural language processing or data mark-up. For example, the monetary value may be encapsulated in a “price” tag such as “<PRICE>$25</PRICE>” or a table field such as:

<TR><TH>Product<TH>Price

<TR><TD>Parking Permit<TD>$25.

Each response message is returned to the request processor 132, which processes the responses to extract four second level budget values and collate these values such that they are associated with text descriptions of transaction items returned from the first query. In the case that an XML document is returned with second level budget values and text descriptions, the XML document is processed by the application operating on the computing device 120 so as to display the second level budget values and text descriptions in second level budget table 1116.

As another example, a user may be aiming to buy a house. Two associated expense items with this goal may be a mortgage and home insurance policy. User information may be used to retrieve accurate quotes for these two expense items from financial institutions. For example, a user may enter a salary, a desired number of bedrooms and a postcode of a desired house into the computing device 120. In this example, the information is submitted to the information server 130. The information server 130 uses the postcode and number of bedrooms to look up an average house price, for example using an API to query a land registry or real estate database. A returned average house price is then used by the information server 130 to construct a second query, together with the salary information, to be sent to a mortgage provider or mortgage rate aggregation website. A monthly amount is then returned to the information server 130. The information server 130 also then generates a third query for a monthly insurance premium quote based on the postcode and the number of bedrooms. The budget values returned by the second and third queries are then returned to the computing device 120 so that a monthly budget amount for a new house may be displayed to the user.

The budget values in the second level budget table 1116 may comprise values returned from a plurality of different local and/or remote queries as described above. They may be returned in a single response message or returned over two or more response messages. In the latter case the request processor 132 waits until all response messages have been received before collating the information at step 660.

The budget values in the second level budget table 1116 may be summed to provide a total budget value of “$300” for the monthly amount estimated to run a motor vehicle. The actual spending patterns of a user may be monitored, in a similar way to that described in association with FIG. 1, in order to determine that a user is keeping within the set budget. This demonstrates how budget values may relate to spending goals as well as savings goals. Similar user interfaces may be used for spending goals as well as savings goals. For example, FIG. 8 could equally be used to illustrate a user's actual spend for each month compared to a budget aim. In this latter case, the “Adjust” control 830 may allow a user to adjust the estimated expense items and/or budget values shown in FIG. 11. For example, if a user consistency overspends or underspends a budget aim, a different set of budget references 500 may be chosen. The nature of the overspend or underspend may be used to determine the set of budget references 500.

In certain examples, the seventh user interface 1110 of FIG. 11 is linked with the first user interface 210 of FIG. 2A and/or the second user interface 250 of FIG. 2B. For example, the seventh user interface 1110 may be displayed when clicking or double clicking on a graphical control element on the first user interface 210, such as the text “Car”, the cell of the first level budget table 216 containing the budget value “$300”, or the bar chart 212 that is indicating the selected budget level. Alternatively, the seventh user interface 1110 may be viewed by selecting at least one of view goals option 322 or adjust amounts option 351 as shown in FIG. 3.

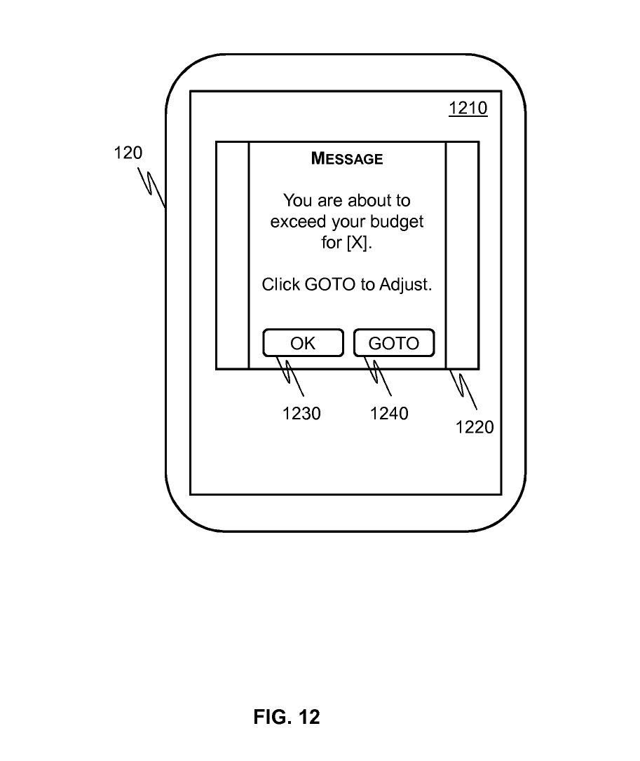

A number of variations will now be described. As a first variation, alert messages associated with a budget or savings goal may be displayed to a user. FIG. 12 is a simplified schematic illustration showing an exemplary computing device 120 displaying an alert message 1220. The alert message 1220 indicates to a user when they are likely to exceed a spend budget value. It may be provided on top of an underlying user interface 1210. As described above, in certain cases, one or more of the computing device 120 or the information server 130 compare an actual spend in a particular category with a target budget value. For example, if a “Car_Running”, i.e. motor vehicle operating costs, category has a budget value of “$300” for a monthly spend, when data for the month from one or more financial accounts indicates that transaction items within that category are about to exceed the budget value (e.g. a particular threshold such as 90% of the budget value has been exceeded), a trigger is initiated to display the message. If the processing and monitoring is performed by the information server 130, for example based on financial data retrieved from one or more data providers 160, 170, 180, a message may be sent across network 110 to the computing device 120, which may then trigger the display of a message on the underlying user interface 1210. The alert message 1220 may be cancelled by selecting an “OK” control 1230. Alternatively, a further “GOTO” control 1240 may be provided to link to an adjustment user interface, for example one of the fourth user interface 810 of FIG. 8 or the fifth user interface 910 of FIG. 9. For example, a user may wish to increase a budget amount if it is likely to be exceeded. Similar alert messages may also be displayed in relation to savings goal, for example if a monthly savings target is not going to be met (or has not been met), an alert message may be displayed at a time associated with a time period transition.

In certain implementations, alert messages are based on an intelligent analysis of a user's or entity's financial data. For example, an algorithm operating on one or more of computing device 120 and information server 130 monitors transaction data from one or more of the first data provider 160, the second data provider 170 and the third data provider 180. A trigger for an alert is set based on, amongst others, one or more of individual transaction amount, cumulative transaction total in a predefined time period (e.g. in a day, week or month), time since a deposit (e.g. since the deposit of a salary or source of funds), historical spending data and percentage thresholds.

For example, a user may wish to reduce their spending on a category of clothes and shoes. In this case, the information server 130 may automatically categorise transactions from particular retail companies as relating to this category. The user sets a spending target for a month using the application on computing device 120, say $200. The information server 130 then regularly accesses transaction data from one or more of the first data provider 160, the second data provider 170 and the third data provider 180. For example, the first data provider 160 may supply transaction information for a current account and the second data provider 170 may supply transaction information for a credit card account. A trigger is set based on one or more of the variables set out above. The information server 130 may trigger message alerts if the user is prone to going over budget, for example information server 130 may compare historic transactions for a plurality of months with a spending budget and if a monthly total for the category regularly exceeds a target spending budget alert messages are activated. The information server 130 is also arranged to analyse the dates of transactions within a particular category for a particular time period to configure the timing of alert messages. Statistical measures relating to the date within a month that a spending budget is exceeded may be used to set an initiation date within a month from which point alert messages may be sent. For example, over a plurality of monthly sample periods, an average number of days from the deposit of funds that a spending budget is exceeded (e.g. 15 days) or a minimum number of days from the deposit of funds that a spending budget is exceeded (e.g. 5 days) may be used to set the initiation date (e.g. alert messages may be transmitted after 15 or 5 days). For example, after 5 days from a funding deposit the information server 130 may send an alert message to the user saying “You have spent $50 of your budget of $200. You have $150 left for the next 25 days”.

A trigger for the sending of messages may be based on a percentage spent from a spending budget for a category, such as 50%. This may or may not be combined with the time trigger previously discussed. For example, regardless of a time, whenever 50% of a spending budget is exceeded an alert message is sent to the user. An alert message may inform a user of the amount left in the spending budget and the time left within a particular spending period. For example, if the user spends $150 on clothes from a particular retail company 2 days after a salary deposit, the information server 130 will detect that this transaction is more than 50% of the spending budget of $200 and send an alert message to the computing device 120 saying “You've already spent 75% of your monthly clothes budget. If you want to stick to your budget you only have £50 left to spend on clothes over the next 28 days”.

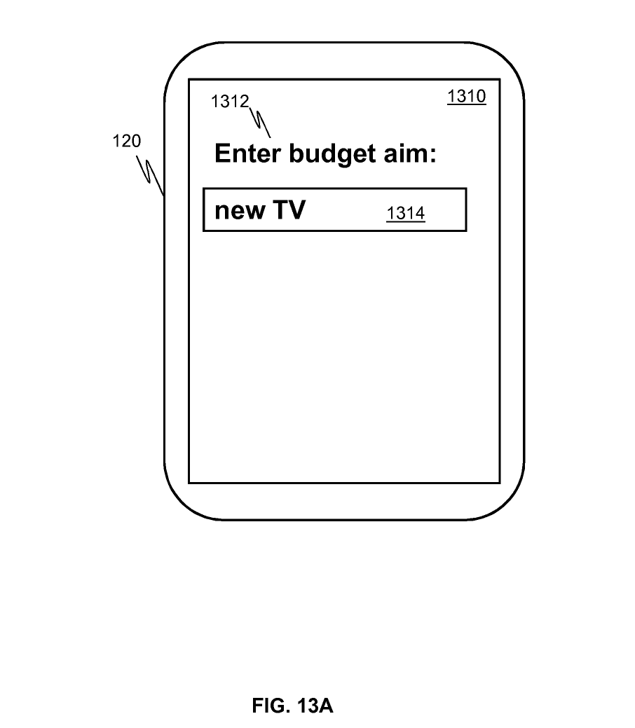

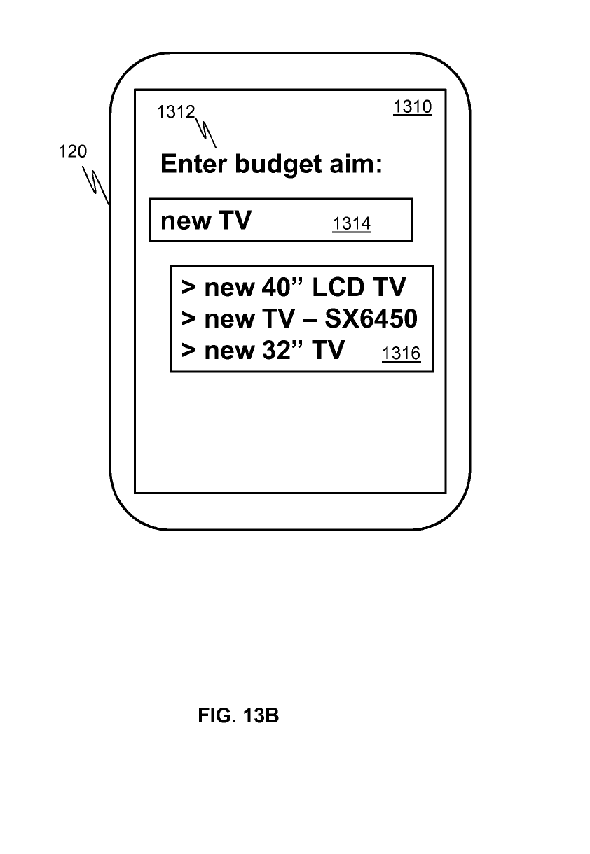

As a second variation, a user may enter a search string to initiate a request for a budget value. For example, FIG. 13A shows a simplified example where a user is presented with a text box 1314 below a budget aim title 1312. The user may use the text box 1314 to enter a budget aim. A search string may be entered using a keyboard, either physical or virtual, using speech-to-text capabilities, and/or via selection using a touch screen panel or interface device such as a mouse. In FIG. 13A the example search string is “new TV”.

In the second variation the search string may comprise at least a portion of the request that is sent to the request processor 132. The request processor 132 may process the search string so as to generate a query string for one or more of a local and remote query to retrieve a budget value. For example, one of first reference server 510 and second reference server 520 of FIG. 5 may comprise a price comparison service that has an API or HTML/XML output. The request processor 132 may thus compose a query for the API based on the search string. The request processor 132 may exclude certain known words in the search string. For example, the word “new” may be unnecessary for a price comparison service API and so may be removed by the request processor 132. In the present example, one or more cost values for a TV may be returned by one or more of the first reference server 510 and the second reference server 520. These cost values may be processed and returned to the computing device 120 for display as a budget value. The computing device 120 may provide the user with the ability to split the budget value over a time period. For example, the user may provide a desired number of months or a desired monthly save amount and then the computing device 120 may process the returned budget value to fit these requirements. In this case, if the returned monetary value for the aim or outcome of a new TV is $400 and the user wishes to save for 12 months to afford this item then a monthly budget value of $33.33 may be set and displayed to the user. Alternatively, if a user inputs that they wish to purchase this item in 6 months, a monthly budget value of $66.66 may be returned. As illustrated here, the budget totals and values may be allowed to have a predetermined tolerance, e.g. variations of 10% or 20% may be allowed.

In a third variation, the system for obtaining and processing financial data 100 may conserve resources by using the results of previously submitted requests for budget values. For example, the search string in text box 1314 may be compared with a database of previously submitted search strings to determine if a probabilistic match is available. This may be a database local to the computing device 120 or information database 136. FIG. 13B shows three returned requests that are presented to a user in request box 1316. The search strings shown in request box 1316, for example, represent previous submitted queries that have a probabilistic match with the phrase “new TV”. Each of the previously submitted queries may have locally stored data, either on computing device 120 or information server 130 that avoids the need for further queries on budget references 500 of FIG. 5.

In a fourth variation, a user-entered search string may be converted into a query using natural language processing (NLP) and/or keyword analysis.

In a fifth variation, the user may be given an option to choose a particular set of one or more budget references 500; for example, a preferred supplier of services or a particular budget reference based on the user's spending requirements. In the latter case, a user may be given the option to pick one of “lowest cost estimate”, “highest cost estimate” and “average cost estimate”, or this selection may be based on a user's spending history. A cost level may be set to a higher cost estimate if a user's spending history for the particular category or financial aim or goal is higher than a returned budget value or alternatively, if a spend consistently overshoots a budget value target the computing device 120 may provide a link, such as a hyperlink, to a lower cost provider of one or more expense items making up the category. For example, if a user is consistently spending more on office supplies that is set by a budget value a search may be performed for a lower budget estimate and the provider or budget reference that provides such an estimate may be presented to a user as an alternative provider of office suppliers.

In a sixth variation, the user may be given a “buy item now” budget value that is equivalent to the cost of buying one or more expense items using credit, such as a credit card or store card, i.e. that includes a credit interest amount such as 29% over a fixed time period (e.g. 24 months). The user may also be given a “save for item” budget value for the same fixed time period that shows the amount that needs to be saved (e.g. each month) to afford to buy one or more expense items after the fixed time period has expired. Alternatively, the budget value for a “save for item” case may be set as equivalent to the credit or “buy item now” but the time period in which funds must be allotted may be reduced (e.g. as interest is not being paid). For example, a user may need to budget for 24 months to “buy item now” but only wait 18 months to save up for the one or more items.

In a seventh variation, the computing device 120 may comprise a local data store that is arranged to store budget values for one or more categories or financial aims or goals.

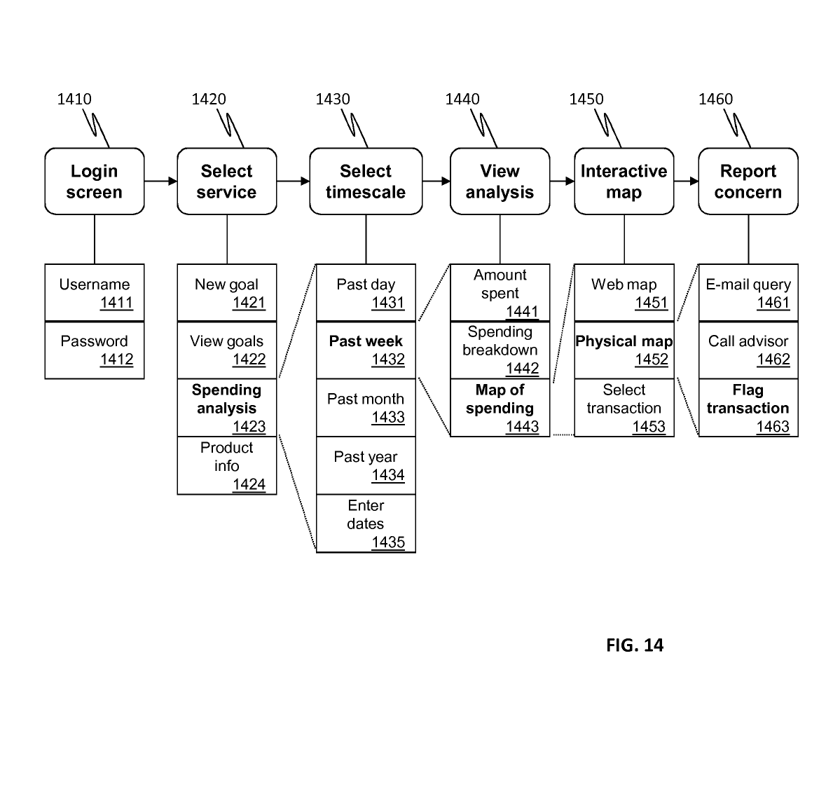

In an eighth variation, location data may be incorporated into the budgeting process. FIG. 14 shows a process for viewing a spending analysis that includes the use of location data. At step 1410, as with steps 310 and 710, a user logs in to the system if they are not already authenticated. For example, a user may enter a username 1411 and password 1412, or these may be passed to a server automatically based on credentials stored on the computing device 120. At step 1420, as with steps 320 and 720, a user selects a service from one of: new goal 1421, view goals 1422, spending analysis 1423 and product information 1424. In the example of FIG. 14, spending analysis 1423 is selected. At step 1430 a timescale for the spending analysis is selected. This may comprise a spending analysis with regard to: the past day 1431; the past week 1432; the past month 1433; the past year 1434; or a custom date range entered using option 1435. The time periods offered as options may be in relation to the current date, for example for one month previous to the current date or for the financial month the current date resides in. The date range is used as a filter for transaction items, e.g. all transaction items with a date within the selected range are retrieved. At step 1440 an analysis of spending is viewable. The spending analysis may comprise, for the selected date range: a total amount spent 1441; a spending breakdown for one or more categories 1442, for example an analysis similar to that shown in FIG. 10; and a spending map 1443. In FIG. 1440 the spending map 1443 is selected to display an interactive map of spending at step 1450. Each transaction item may have geospatial metadata, for example in the form of latitude and longitude coordinates, a place name, and/or a postal (e.g. zone improvement plan—ZIP) code. An institution or organisation associated with a transaction item may also provide location information, for example, a retail establishment may be identified in a transaction item and the location of the retail establishment may be available from public or proprietary databases. Based on the geospatial metadata a transaction item can be identified within a networked mapping service 1451, such as OpenStreetMap, or on a map stored on the computing device 1452. In certain examples, each transaction item within the selected date range is allotted a marker or pin on a map displayed on the computing device; by selecting the marker or pin 1453 information associated with the transaction item is displayed. At step 1460, questionable transaction items shown on a displayed map may be selected by a user and reported as a concern. For example, a query can be emailed at step 1461, an advisor may be called at step 1462 and a transaction may be marked as flagged at step 1463.

In a particular implementation, one or more of the computing device 120 and the information server 130 actively alert users of fraud using geospatial data and a map interface. In this case, the information server 130 uses historic transaction data to determine common locations for transactions. These common locations could be represented as a geospatial area. If a transaction occurred outside of this geospatial area, or a particular distance outside of this geospatial area, the information server 130 flags the transaction as anomalous and sends an alert message to the computing device 120 of the user. In another implementation, a Global Navigation Satellite System signal, such as a Global Positioning System (GPS) signal, may be used to locate a user over a time period. For example, computing device 120, or a mobile telephone belonging to the user, may comprise a GPS receiver and may log location data. Location data associated with a user may then be compared to geospatial metadata associated with one or more transaction items to determine if said transaction items should be flagged as anomalous. For example, if there is a mismatch between the geospatial metadata and the user location data, such as a difference in location above a particular threshold to account for positioning errors, this can be used to trigger an anomalous status and an alert message. The alert message may resemble the alert messages of FIG. 12. The alert message may comprise a link to the location of the anomalous transaction, such as a latitude and longitude co-ordinate. This link may then be rendered on a mapping application, or networked mapping service 1451 used by the computing device 120, when activated by a user. For example, the location of an anomalous transaction may be marked with a red flag in a mapping application, or networked mapping service 1451. In one implementation, statistical methods are used to determine the likelihood that the location of a transaction relates to a user. Historic data may be used to generate a probability model; in a simple case a travel pattern of a user may be normally (i.e. Gaussian) distributed around a home location. The probability of a transaction belonging to a user may decrease with distance from the home location. In this case, an alert may be triggered when the likelihood of a transaction location belonging to a user falls below 5%. Different probability ranges may be marked with different coloured flags; for example, a green, amber, red traffic-light system may be used. Users may be able to set a threshold for when they wish to receive an active fraud alert.

Geospatial data associated with transaction items may be used to select relevant ancillary information for fulfilling a budget value request. For example, if a category or sub-category of transaction items is limited to a particular geographical area (e.g. if 80% of transactions in a particular category or sub-category are within a 20-mile radius) then this particular geographical area can be used as a constraint when submitting queries to retrieve expense item data. For example, the average monthly cost of transaction items marked as parking tickets may vary from area to area. When budgeting for motor vehicle running costs the average monthly spend may depend on a particular geographical area, which is submitted with a query based on the location of previous parking ticket transaction items. Similarly, when saving for a house a user may enter a desired postal code or area. Anonymised and/or averaged transaction items located in the desired postal code or area may then be used to provide estimated budget values for expense items such as building work, gardening work, electricians etc.

In a ninth variation, a number of options for viewing transactions mapped with geospatial data are provided. In a first option, transactions marked on a map may be filtered by one or more of the computing device 120 and information server 130. A filter may be applied to restrict the viewable transactions. The filter may be set based on, amongst others, one or more of time/date (e.g. last month), transaction amount (e.g. exclude transaction amounts under £10) and category (e.g. to enable a user to view where they spend the most money on clothes or entertainment). In a second option, a user interface upon the computing device 120 offers users the ability to manually add flags and notes to particular transactions viewed on a map. This enables transaction data to be enriched using user contributions. These contributions may be sent to information server 130 and/or one or more of the data providers. This user interface offers users the ability to colour-code flags added to particular transaction locations; for example, they may use a purple flag to show transactions made by the user on behalf of a third party such as a friend, so at a glance they can easily identify all those transactions.

In a tenth variation, a budget adjustment such as that shown in FIG. 10 may be performed automatically. For example, spending in a certain category or sub-category may be locked by the user (e.g. by selecting a sector of a pie chart for a particular time period or by selecting a “lock” icon). Spending in any remaining unlocked categories or sub-categories may then be reduced to accommodate a financial amount to save for a time period. Certain categories or sub-categories may be reduced by weighted amounts. These weighted amounts may be learnt based on successful budgeting by other users. For example, if other users reduce an entertainment spend by an average of 30% and a household spend by an average of 5% this weights may be used to reduce a user's spend such that 30% of the spend reduction comes from the entertainment category and 5% from the household category.

In an eleventh variation, one or more of the computing device 120 and the information server 130 may be arranged to monitor ancillary information for a time period following the setting of a budget level or target saving goal. For example, if a user is saving for a retail purchase item (such as expensive electronics), the information server 130 may be arranged to regularly search one or more external data sources for current sales prices to identify a reduction in price for a target expense item. The one or more external data sources may comprise the first and/or second reference servers 510, 520 that were used to originally retrieve the ancillary information or another external data source. Referring to the example of the second variation, assume a user has set a savings goal for a particular model of new TV. At the time of setting up the savings goal, ancillary information was retrieved that estimated the monetary value for the aim or outcome of the particular model of new TV to be $400. If the user is partway to the savings goal of $400, say has saved $300, the information server 130 uses the partway savings total to perform a daily search of one or more external data sources. The information server 130 may perform the search as a scheduled activity. If the searches of the information server 130 return a new reduced price that is below the partway saving total this is indicated to the user, e.g. in the form of an alert message similar to FIG. 12. For example, a search may comprise a query to return any entries in an online retailer's inventory that match the TV model specifications entered by a user and the current partway savings total. If such an item exists, e.g. because the particular model has now been reduced in price from $400 to $299, then an alert message is displayed on the computing device 120 saying e.g. “The TV you are saving for is currently available for $299 at [Retailer Z], which means you have saved enough to complete your savings goal today”.

The embodiments described herein provide a system and a method that enables automatic retrieval of representative cost information when budgeting for a particular project or expenses. This improves a user's ability to budget for spending or saving. For example, if budget values accurately represent a future spend or savings amount a user can better manage and apportion their income and/or commercial entity's revenue.

According to certain examples described herein there is a method for retrieving financial data for a budget, comprising: receiving, by a computer, a request for at least one monetary value representative of a sum of money to allocate for a particular outcome; parsing, by a computer, the request to determine at least one expense item required to achieve the particular outcome; retrieving, by a computer, ancillary information relating to said at least one expense item, the ancillary information comprising a cost value representative of said at least one expense item; and processing, by a computer, the retrieved ancillary information to output said at least one monetary value.

The step of parsing the request may comprise identifying the particular outcome from the request to return an outcome identifier and using at least the outcome identifier to retrieve a group of expense items associated with the particular outcome from a database. In certain cases, the request identifies an entity and the step of using at least the outcome identifier to retrieve a group of expense items comprises using at least the outcome identifier and information relating to the entity to retrieve a subset of expense items associated with the particular outcome from the database.

In one example, the step of retrieving ancillary information comprises generating a query for each expense item and executing each query against one or more data sources. The step of generating a query for each expense item may comprise retrieving a resource identifier associated with each expense item, the resource identifier being associated with an address of a data source.

In one example, the method comprises selecting, using a graphical user interface, a category representative of the particular outcome, the category being used to generate the request for a monetary value.

In one example, the method comprises receiving, using a graphical user interface, a search string from a user so as to generate the request for a monetary value. In this case, the method may further involve determining whether an outcome identified in the search string has a relationship with an outcome present in a previously submitted request for a monetary value and, if there is a relationship, using at least a portion of previously retrieved ancillary information relating to the previously submitted request to output a monetary value for the outcome identified in the search string. Additionally, there may be steps of presenting, on a graphical user interface, a user with at least one outcome that featured in a previously submitted request, the at least one outcome having a probabilistic match with the search string and, on selection of the at least one outcome, using at least a portion of previously retrieved ancillary information relating to the previously submitted request to output a monetary value for the outcome identified in the search string. If a user does not select the at least one outcome that featured in a previously submitted request, the receiving, parsing, retrieving and processing steps may be performed using the search string as a portion of the request for a monetary value.

The method may comprise outputting the cost values, i.e. low-level budget values, of one or more expense items. This step may in turn involve selecting a subset of the output cost values to generate a total monetary value representative of a sum of money to allocate for a particular outcome.

In one example, the step of processing the retrieved ancillary information comprises processing an electronic document to extract one or more cost values. This may involve performing a statistical calculation on a plurality of cost values extracted from the electronic document to generate a single cost value estimate.

In one example, the step of retrieving comprises retrieving ancillary information from one or more remote servers over one or more communication networks.

According to certain examples described herein there is an apparatus for retrieving financial data for a budget, comprising a request processor arranged to receive a request for at least one monetary value representative of a sum of money to allocate for a particular outcome, parse the request to determine at least one expense item required to achieve the particular outcome, prepare one or more queries for said at least one expense item, receive, in response to said one or more queries, ancillary information, the ancillary information comprising a cost value representative of said at least one expense item and process the retrieved ancillary information to output said at least one monetary value.

The apparatus may comprise an information database coupled to the request processor for retrieving a set of one or more expense items based on an outcome identified in the request.

According to certain examples described herein there is a system for retrieving financial data for a budget, comprising a computing device arranged to generate a request for at least one monetary value representative of a sum of money to allocate for a particular outcome, an information server arranged to receive the request and generate one or more queries for one or more respective expense items required to achieve the particular outcome and one or more reference servers arranged to receive said one or more queries and return data comprising cost values representative of said one or more expense items.

In certain examples, at least one of the computing device and the information server is arranged to receive said data returned from the one or more reference servers and generate a total monetary value representative of a sum of money to allocate for the particular outcome.

The above embodiments are to be understood as illustrative examples of the disclosure. In particular, exemplary functions have been necessarily simplified for ease of explanation. Further embodiments of the disclosure are envisaged. For example, in certain embodiments the functionality of the information server 130 may be included locally within the computing device 120. In this case, one or more queries for ancillary information relating to a budget may be prepared and sent by the computing device 120 and query results may be returned directly to said same device. The terms “budget value”, “spending target” and “target savings goal” are used to refer to a numerical data value representative of a process of allotting financial resources towards an aim or goal outcome. In certain embodiments budget references 200 may form part of the information server 130, part of a private network comprising the information server 130 or data sources accessible by one or more of request processor 132 or database interface 134 of the information server 130. In certain embodiments, the ancillary information is retrieved automatically from third party data sources. In other embodiments, the ancillary information may be curated manually and stored locally in the information database 136. In certain embodiments, the user may select and un-select second level budget values that contribute to a budget total. For example, a particular user may not need a parking permit and so they may un-select the “Permit” second level budget value so the total budget value is reduced from “$300” to “$250”. It is to be understood that any feature described in relation to any one embodiment may be used alone, or in combination with other features described, and may also be used in combination with one or more features of any other of the embodiments, or any combination of any other of the embodiments. The variations described above may also be used in any combination. Furthermore, equivalents and modifications not described above may also be employed without departing from the scope of the disclosure, which is defined in the accompanying claims.

1. A method for retrieving financial data for a budget, comprising:
receiving, by a computer, a request for at least one monetary value representative of a sum of money to allocate for a particular outcome;
parsing, by a computer, the request to determine at least one expense item required to achieve the particular outcome;
retrieving, by a computer, ancillary information relating to said at least one expense item, the ancillary information comprising a cost value representative of said at least one expense item; and
processing, by a computer, the retrieved ancillary information to output said at least one monetary value.

2. A method according to claim 1, wherein the step of parsing the request comprises:
identifying the particular outcome from the request to return an outcome identifier; and
using at least the outcome identifier to retrieve a group of expense items associated with the particular outcome from a database.

3. A method according to claim 2, wherein the request identifies an entity and the step of using at least the outcome identifier to retrieve a group of expense items comprises using at least the outcome identifier and information relating to the entity to retrieve a subset of expense items associated with the particular outcome from the database.

4. A method according to claim 1, wherein the step of retrieving ancillary information comprises:
generating a query for each expense item; and
executing each query against one or more data sources.

5. A method according to claim 4, wherein the step of generating a query for each expense item comprises retrieving a resource identifier associated with each expense item, the resource identifier being associated with an address of a data source.

6. A method according to claim 1, comprising:
selecting, using a graphical user interface, a category representative of the particular outcome, the category being used to generate the request for a monetary value.

7. A method according to claim 1, comprising:
receiving, using a graphical user interface, a search string from a user so as to generate the request for a monetary value.

8. A method according to claim 7, comprising:
determining whether an outcome identified in the search string has a relationship with an outcome present in a previously submitted request for a monetary value; and
if there is a relationship, using at least a portion of previously retrieved ancillary information relating to the previously submitted request to output a monetary value for the outcome identified in the search string.

9. A method according to claim 7, comprising:
presenting, on a graphical user interface, a user with at least one outcome that featured in a previously submitted request, the at least one outcome having a probabilistic match with the search string; and
on selection of the at least one outcome, using at least a portion of previously retrieved ancillary information relating to the previously submitted request to output a monetary value for the outcome identified in the search string.

10. A method according to claim 9, wherein if a user does not select the at least one outcome that featured in a previously submitted request, the receiving, parsing, retrieving and processing steps are performed using the search string as a portion of the request for a monetary value.

11. A method according to claim 1, comprising:
outputting the cost values of one or more expense items.

12. A method according to claim 11, comprising:
selecting a subset of the output cost values to generate a total monetary value representative of a sum of money to allocate for a particular outcome.

13. A method according to claim 1, wherein the step of processing the retrieved ancillary information comprises processing an electronic document to extract one or more cost values.

14. A method according to claim 13, comprising:
performing a statistical calculation on a plurality of cost values extracted from the electronic document to generate a single cost value estimate.

15. A method according to claim 1, wherein the step of retrieving comprises retrieving ancillary information from one or more remote servers over one or more communication networks.

16. A method according to claim 1, comprising:
monitoring at least one data source for a change in the ancillary information; and
displaying a message if a change in the ancillary information is determined.

17. A method according to claim 1, comprising:
determining a current amount allocated to the particular outcome at a time before an amount greater than the at least one monetary value has been allocated to the particular outcome;
retrieving updated ancillary information relating to said at least one expense item;
determining if a new cost value representative of said at least one expense item is less than the current amount; and if so,
displaying a message alerting a user, the message indicating that the particular outcome can be achieved.

18. Apparatus for retrieving financial data for a budget, comprising:
a request processor arranged to:
receive a request for at least one monetary value representative of a sum of money to allocate for a particular outcome;
parse the request to determine at least one expense item required to achieve the particular outcome;
prepare one or more queries for said at least one expense item;
receive, in response to said one or more queries, ancillary information, the ancillary information comprising a cost value representative of said at least one expense item; and
process the retrieved ancillary information to output said at least one monetary value.

19. Apparatus according to claim 18, comprising:
an information database coupled to the request processor for retrieving a set of one or more expense items based on an outcome identified in the request.

20. A system for retrieving financial data for a budget, comprising:
a computing device arranged to generate a request for at least one monetary value representative of a sum of money to allocate for a particular outcome;
an information server arranged to receive the request and generate one or more queries for one or more respective expense items required to achieve the particular outcome; and
one or more reference servers arranged to receive said one or more queries and return data comprising cost values representative of said one or more expense items.

21. A system according to claim 20, wherein at least one of the computing device and the information server is arranged to receive said data returned from the one or more reference servers and generate a total monetary value representative of a sum of money to allocate for the particular outcome.
